(19) United States
(12) Patent Application Publication
(10) Pub. No.: US 2013/0335915 A1
(43) Pub. Date: Dec. 19, 2013

(54) ELEVATING MECHANISM AND DOCKING STATION USING THE SAME

(71) Applicant: HON HAI PRECISION INDUSTRY CO., LTD., New Taipei (TW)

(72) Inventors: YEN-HAO LAI, New Taipei (TW); CHIH-HUNG TSAI, New Taipei (TW)

(73) Assignee: HON HAI PRECISION INDUSTRY CO., LTD., New Taipei (TW)

(21) Appl. No.: 13/786,504

(22) Filed: Mar. 6, 2013

(30) Foreign Application Priority Data
Jun. 15, 2012 (CN) 2012101978830

(51) Int. Cl. H01R 13/44; G06F 1/16

(52) U.S. Cl. CPC H01R 13/44; G06F 1/1632
USPC 361/679.44; 439/131

(57) ABSTRACT

A docking station for an electronic device includes a housing, an elevating mechanism, and a connector. The elevating mechanism is received in the housing. The connector is secured to the elevating mechanism and is driven by the elevating mechanism to move between a working position when it is protruding out of the housing, for communicating with the electronic device, and an unworking position when it is retracting into the housing. An elevating mechanism used in a docking station is also provided.

### BACKGROUND

1. Technical Field

The present disclosure relates to a docking station; and particularly to a docking station with an elevating mechanism.

2. Description of Related Art

Portable computers, mobile phones and music players are widespread because of their relatively small size and portability. However, a small-sized electronic device has limited number of ports, and expandability of the electronic device is restricted. To compensate for the restricted expandability, the electronic device is typically provided with a docking station via which the electronic device may be connected with a mouse, a modem, and/or other peripheral equipment.

Generally, the docking station includes a connector for mating with a socket of the electronic device. When the electronic device is positioned on the docking station, the connector electrically connects to the socket for expanding functions of the portable computer. However, over time and with repeated use, the connector and/or the socket may loosen and the electrical connectivity becomes unreliable.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a docking station for an electronic device.

FIG. 2 is a partial, exploded view of the docking station of FIG. 1.

FIG. 3 is a further exploded view of the docking station of FIG. 2.

FIG. 4 is a partial, isometric view of the docking station of FIG. 3.

FIG. 5 is an isometric view of the docking station of FIG. 1 in a first state.

FIG. 6 is an isometric view of the docking station of FIG. 1 in a second state.

### DETAILED DESCRIPTION

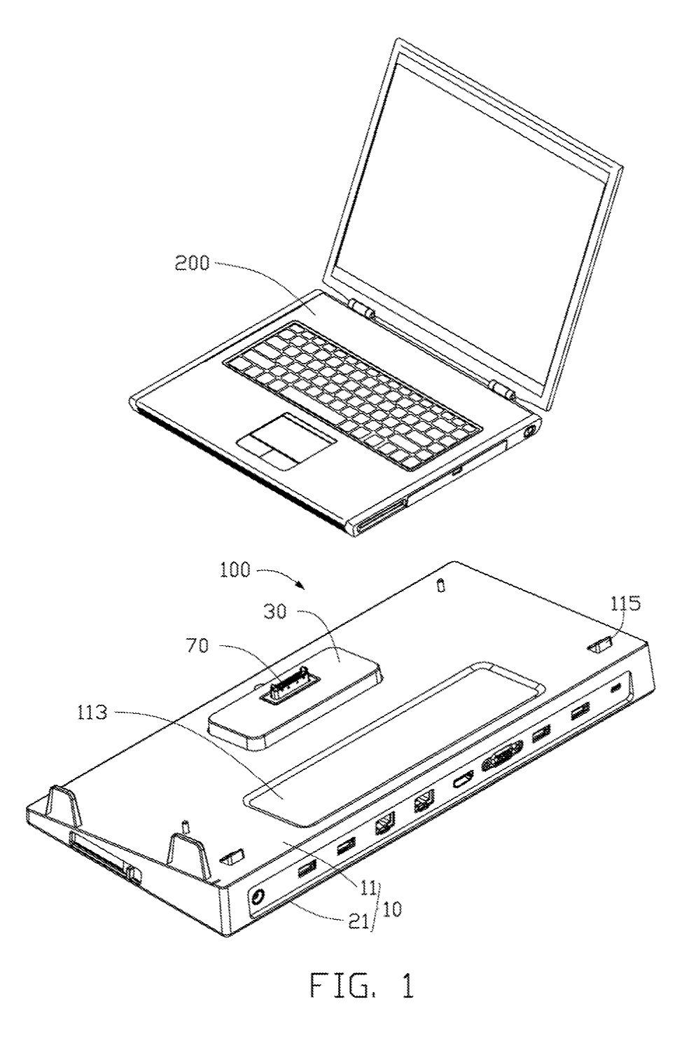

FIG. 1 illustrates a docking station 100 for an electronic device 200. The docking station 100 includes a housing 10, an elevating mechanism 30 and a connector 70. The elevating mechanism 30 is received in the housing 10. The connector 70 is secured to the elevating mechanism 30 and is moved between a working position where the connector 70 is exposed out of the housing 10 for electrically connecting with the electronic device 200, and an unworking position where the connector 70 is retracted into the housing 10 by the virtue of the elevating mechanism 30. In the embodiment, the electronic device 200 is a portable computer. In other embodiments, the electronic device 100 may be a mobile phone or a music player or the like.

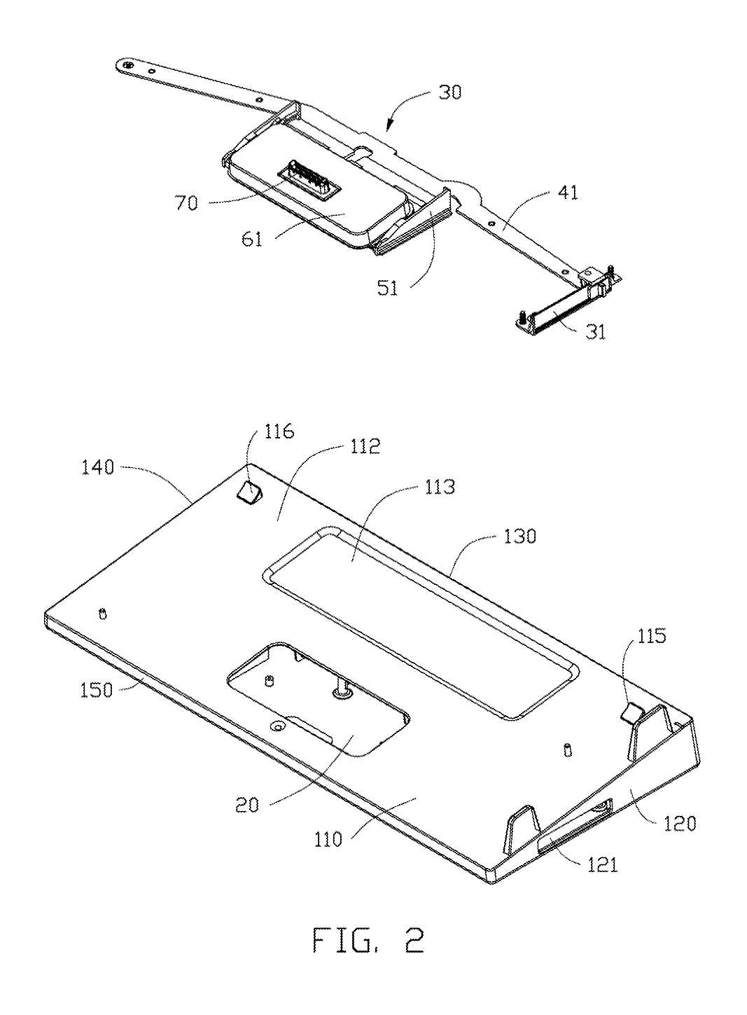

The housing 10 is substantially rectangular. The housing 10 includes an upper cover 11 and a lower cover 21 opposite to the upper cover 11. The upper cover 11 cooperates with the lower cover 21 to define a receiving space 20 (see FIG. 2) for receiving the elevating mechanism 30 and other components of the docking station 100.

Referring to FIG. 2, the upper cover 11 includes an upper wall 110, a first sidewall 120, a second sidewall 130, a third sidewall 140 opposite to the first sidewall 120, and a fourth sidewall 150 opposite to the second sidewall 130. The first, second, third and fourth sidewalls, 120, 130, 140 and 150, perpendicularly and upwardly extend from four rims of the upper wall 110.

The upper wall 110 includes an upper surface 112. A recessed portion 113 is recessed in the upper surface 112 and near the second sidewall 130. The recessed portion 113 corresponds to a heat sink portion (not shown) positioned on the bottom of the electronic device 200. When the electronic device 200 is placed on the docking station 100, a predetermined gap is formed between the heat sink portion and the recessed portion 113, for dissipating heat produced by the electronic device 200. Two positioning portions 115 protrude from the upper surface 112. The positioning portions 115 are positioned on opposite ends of the recessed portion 113 and are aligned parallel to the second sidewall 130. In the embodiment, each positioning portion 115 defines an inclined surface 116 opposite to the upper surface 112, for guiding the electronic device 200 onto the docking station 100.

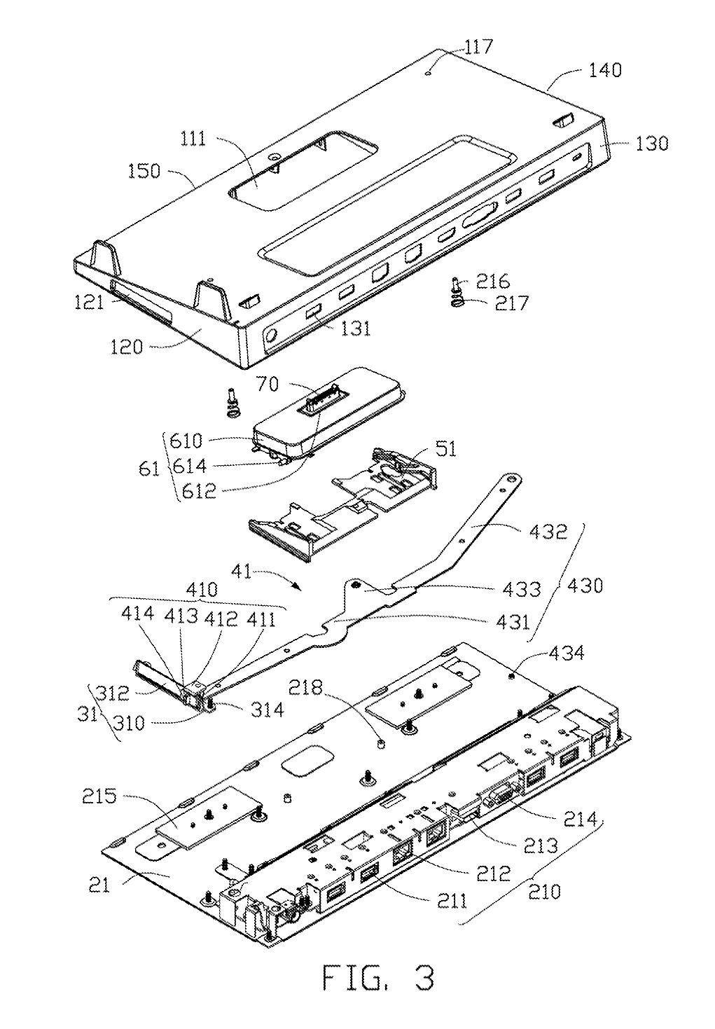

Referring also to FIG. 3, the upper wall 110 further defines an opening 111 and two through holes 117. The opening 111 is substantially rectangular and is arranged between the fourth sidewall 150 and the recessed portion 113, with the length thereof parallel to the fourth sidewall 150. The opening 111 communicates with the receiving space 20 for allowing the connector 70 to be exposed from the upper cover 11. The two through holes 117 are defined at opposite ends of the opening 111.

The first sidewall 120 defines a receiving slot 121. The receiving slot 121 extends in a direction parallel to the first sidewall 120. The second sidewall 130 defines a plurality of spaced fixing holes 131.

The lower cover 21 is substantially rectangular. A plurality of interfaces 210 are secured to the lower cover 21 and correspond to the fixing holes 131. The interfaces 210 are positioned on an end of the lower cover 21 near the second sidewall 130 and are parallel to the second sidewall 130. When the upper cover 11 covers the lower cover 21, the interfaces 210 extend through the fixing holes 131 and are exposed out of the second sidewall 130, for electrical connections to peripheral equipments. In the embodiment, the interfaces 210 includes four universal serial bus interfaces 211, two ethernet interfaces 212, a high definition multimedia interface 213 and a video graphics array interface 214. Two spaced guiding plates 215 are positioned on an end of the lower cover 21 opposite to the interfaces 210. Two conducting components 216 and two spaced resisting posts 218 are positioned on an inner surface of the lower cover 21. The two resisting posts 218 are positioned between the interfaces 210 and the two guiding plates 215, and are aligned so as to be parallel to the fourth sidewall 150. The two conducting components 216 are substantially columnar, and correspond to the two through holes 117. One end of each conducting component 216 is connected to a grounded component (not shown) secured to the lower cover 21 via an elastic component 217, and the other end of each conducting component 216 extends through the through holes 117 and is further in electrical contact with the electronic device 200. Thus, any static electricity from the electronic device 200 can disperse to ground via the two conducting components 216. In the embodiment, the grounding component is made of metal.

The elevating mechanism 30 is received in the receiving space 20. The elevating mechanism 30 includes a fixing component 31, an operating component 41, a driving component 51 and an elevating component 61.

The fixing component 31 is mounted to the receiving slot 121. The fixing component 31 includes a first fixing portion 310 and a second fixing portion 312. The first fixing portion 310 is fixed to the lower cover 21 via a first latching component 314. The second fixing portion 312 perpendicularly extends from a rim of the first fixing portion 310. When the upper cover 11 covers the lower cover 21, the second fixing portion 312 is received in the receiving space 20 and corresponds to the receiving slot 121. A predetermined gap is formed between the receiving slot 121 and the second fixing portion 312.

The operating component 41 is movably secured to the fixing component 31, and is adapted to slide the driving component 51 when it is manipulated. The operating component 41 includes an operating portion 410 and a body 430 connected to the operating portion 410.

The operating portion 410 is slidably secured to the second fixing portion 312, and includes a first arm 411, a second arm 413, a connecting portion 413 and a handle 414. The first arm 411 and the second arm 413 are positioned on opposite surfaces of the second fixing portion 312. The connecting portion 413 is arranged between two ends of the first and second arms 411, 413, opposite to the lower cover 21. Thus, the shape of the operation portion 410 is substantially U-shaped, with an opening receiving the second fixing portion 312. The handle 414 protrudes from a surface of the first arm 411 opposite to the second arm 413 and is exposed out of the receiving slot 121.

The body 430 is substantially a narrow plate. One end of the body 430 is secured to the operation portion 410, and the other end of the body 430 is rotatably secured to the lower cover 21. The body 430 includes a first portion 431, a second portion 432 and a protruding portion 433. The first portion 431 connects to the second arm 433 and can be moved relative to the lower cover 21 by virtue of the operating portion 410. The second portion 432 is inclined at an angle with respective to the first portion 431, and connects to an end of the first portion 431 opposite to the operating portion 410. An end of the second portion 432 opposite to the first portion 431 is rotatably connected to the lower cover 21 through a second latching component 434. The second portion 432 is capable of being rotated around the second latching component 434 with respect to the lower cover 21 by an external force. The protruding portion 433 protrudes from a rim of the first portion 431 near the fourth sidewall 150.

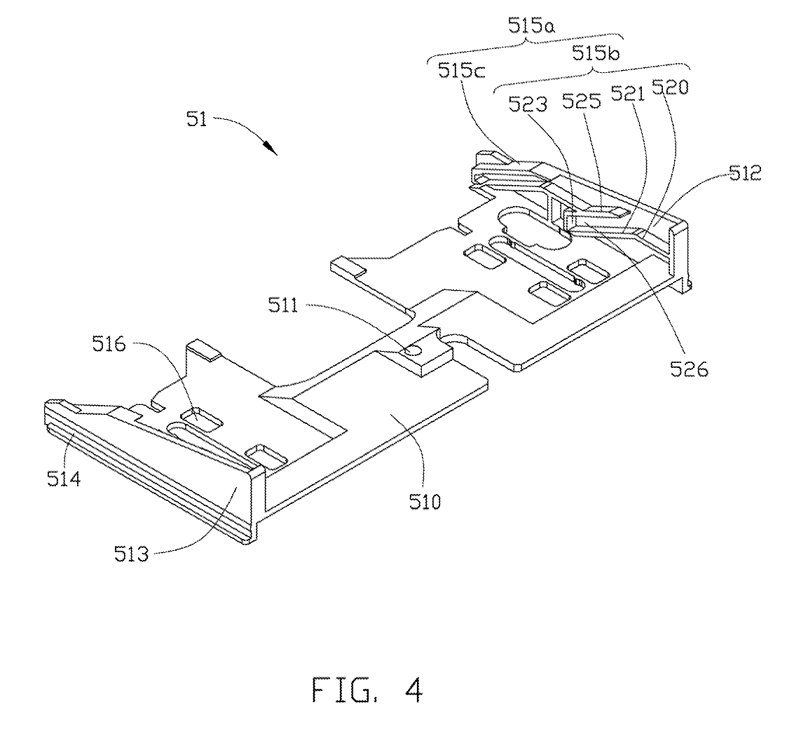

Referring to FIG. 4, the driving component 51 is rotatably secured to the protruding portion 433. The driving component 51 includes a bottom plate 510, a first mounting plate 512, a second mounting plate 513 and two elevating elements 515a. The bottom plate 510 defines a latching hole 511 and two positioning holes 516. The latching hole 511 is defined at the middle portion of the bottom plate 510 and corresponds to the protruding portion 433. The two positioning holes 516 are elongated, and extend in a direction parallel to the first sidewall 120. The positioning holes 516 slideably receive the resisting posts 218 for limiting the sliding movement of driving component 51. The first and second mounting plates 512, 513 perpendicularly extend from opposite rims of the bottom plate 510 and are parallel to the first sidewall 120. Opposite surfaces of the first and second mounting plates 512, 513 define two sliding slots 514 for engaging with the two guiding plates 215.

The two elevating elements 515a have the same configuration and face each other. One of the elevating elements 515a is positioned on a surface of the first mounting wall 512 facing the second mounting wall 513, and the other one of the elevating elements 515a is positioned on a surface of the second mounting wall 513 facing the first mounting wall 512. Each elevating element 515a includes two elevating portions 515b, 515c, which have the same configuration and are connected with each other. For simplicity, only the elevating element 515a positioned on the second mounting wall 513 is described.

The elevating portion 515b is positioned on an end of the first mounting wall 512 near the second sidewall 513. The elevating portion 515b includes a supporting portion 520, an inclined portion 521, a resisting portion 523 and an engaging portion 525, all of which are flat-plates protruding from a surface of the first mounting wall 512 facing the second mounting wall 513. The supporting portion 520 is parallel to the bottom plate 510 and is a predetermined distance from a surface of the bottom plate 510 opposite to the supporting portion 520. The inclined portion 521 is arranged between an end of the supporting portion 520 away from the fourth sidewall 150 and the bottom plate 510. The vertical height of an end of the inclined portion 521 connected to the supporting portion 520 is larger than the vertical height of an end of the inclined portion 521 connected to the lower cover 21. The inclined portion 521 and the bottom plate 510 form an acute angle. The resisting portion 523 is perpendicular to the bottom plate 510 and connects to an end of the inclined portion 512 away from the second sidewall 140. The engaging portion 525 connects to an end of the resisting portion 523 opposite to the inclined portion 512 and is parallel to the inclined portion 521. Thus, the engaging portion 525, the resisting portion 523 and the inclined portion 521 corporately form a U-shaped groove 526 with an opening facing to the supporting portion 520.

Referring to FIG. 3, the elevating component 61 is slidably secured to the driving component 51. The elevating component 61 includes a base 610 and four sliding posts 614. The base 610 is designed to mate with the shape of the opening 111. The base 610 defines a mounting hole 612 for mounting the connector 70. Two of the sliding posts 614 protrude from an end of the base 610 opposite to the first mounting wall 512 and are spaced from each other, for engaging with the corresponding elevating portions 515b and 515c on the first mounting wall 512. Other two of the siding posts 614 protrude from another end of the base 610 opposite to the second mounting wall 512 and are spaced from each other, for engaging with the corresponding elevating portions 515b and 515c on the second mounting wall 513. In the embodiment, the size of each sliding post 614 is equal to the distance between the engaging portion 525 and the inclined portion 521.

The connector 70 is secured to the base 610 and protrudes out of the base 610 via the mounting hole 612 for electrically connecting with the electronic device 200.

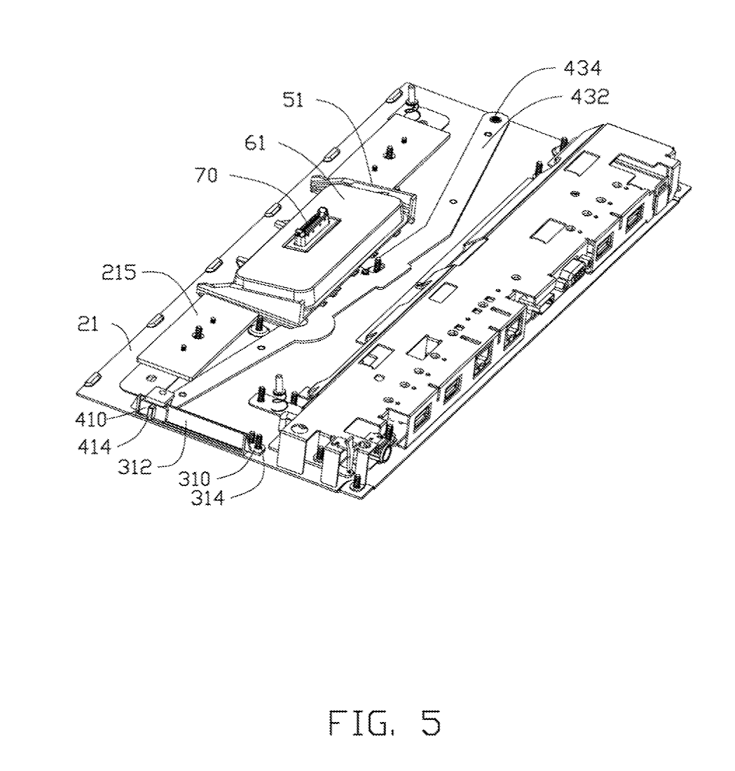

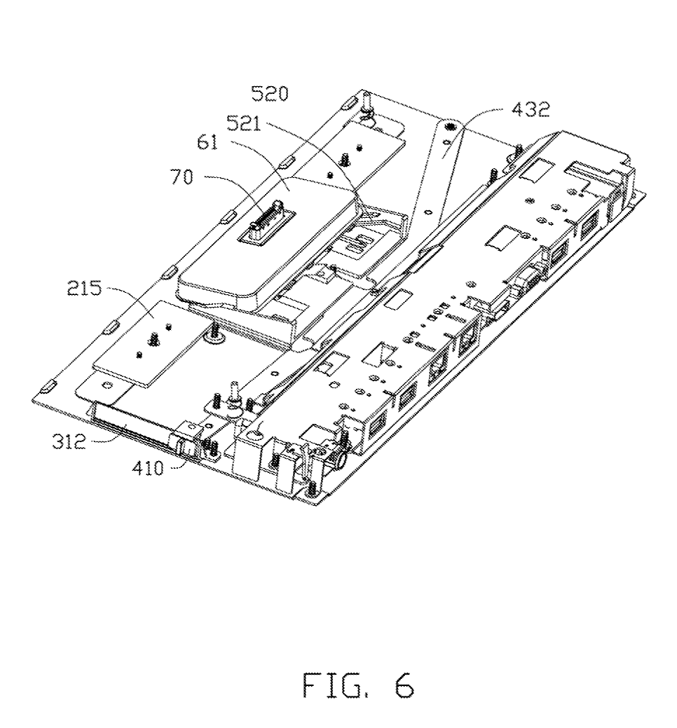

Referring to FIGS. 5 and 6, in assembly, the fixing component 31 is fixed to the lower cover 21 via the first latching components 314. The operating component 41 is rotatably secured to the lower cover 21, with the operation portion 410 slidably connected to the fixing component 31 and the second portion 432 rotatably connected to an end of the lower cover 21 near to the third sidewall 140 via the second latching component 434. The handle 414 protrudes out of a surface of the second fixing portion 312 opposite to the first fixing portion 310 for allowing the user to manipulate the operating component 41. The driving component 51 is fixed to the protruding portion 433, with the two resisting posts 218 received in the corresponding positioning hole 516 and the inclined portion 521. Opposite ends of the guiding plates 215 are received in the sliding slots 514. Each sliding post 614 is slidable in the groove 526. The upper cover 11 covers the lower cover 21, with the connector 70 corresponding to the opening 11 and the operating portion 410 received in the sliding slot 121.

After assembly, the operating component 41 is moved along the second fixing portion 312 back and forth in a first direction parallel to the first sidewall 120, and drives the driving component 51 to move between a first position near to the fourth sidewall 150 and a second position near the second sidewall 130. When the driving component 51 is moved to the first position, the elevating component 61 is raised by the driving component 51, and the connector 70 protrudes out of the housing 11 for electrically connecting with the electronic device 200. When the driving component 51 is moved to the second position, the elevating component 61 is moved down by the driving component 51, and the connector 70 is retracted into the housing 11.

When the user wants to use the connector 70, the user moves the operating portion 410 in the first direction, for driving the operating portion 410 to move toward an end of the second fixing portion 312 near the fourth sidewall 150. The body 430 is driven by the operating portion 410 to rotate around the second latching component 434, and the driving component 51 is driven to move from the second position to the first position along the guiding plates 215. The elevating component 61 slides toward the supporting portion 520 along the inclined portion 521 when the driving component 51 is moved from the second position to the first position. Thus, the vertical height of the elevating component 61 relative to the lower cover 21 gradually increases, and the connector 70 is raised relative to the lower cover 21 in a second direction perpendicular to the lower cover 21. In this state, the connector 70 is in the used position and exposed out of the housing 11 for electrically connecting with the electronic device 200.

When the user wants to retract the connector 70 into the housing 11, the user moves the operating portion 410 in the first direction, for driving the operating portion 410 to move toward an end of the second fixing portion 312 near the second sidewall 150. The body 430 rotates around the second latching component 434, and drives the driving component 51 to move from the first position to the second position. The elevating component 61 slides toward the inclined portion 521 along the supporting portion 520. Thus, the vertical height of the elevating component 61 relative to the lower cover 21 gradually decreases. The connector 70 gradually drops relative to the lower cover 21 in the second direction perpendicular to the lower cover 21. In this state, the connector 70 is in the unused position and retracted into the housing 11.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A docking station for an electronic device, comprising:
a housing;
an elevating mechanism being received in the housing; and
a connector secured to the elevating mechanism;
wherein the connector is capable of being driven by the elevating mechanism to move between a working position protruding out of the housing for communicating with the electronic device and an unworking position retracting in the housing.

2. The docking station as claimed in claim 1, wherein the elevating mechanism comprises a driving component and an elevating component movably secured to the driving component, the connector is secured to the elevating component; the driving component is capable of being moved between a first position for raising the elevating component to expose the connector out of the housing and a second position for dropping the elevating component to retract the connector into the housing.

3. The docking station as claimed in claim 2, wherein the driving component comprises a bottom plate and an elevating portion, the elevating portion comprises a supporting portion and an inclined portion slantingly connected to the supporting portion; the vertical height between an end of the inclined portion connected to the supporting portion and the bottom plate is larger than the vertical height between an end of the inclined portion opposite to the supporting portion and the bottom plate.

4. The docking station as claimed in claim 3, wherein the supporting portion is parallel to the bottom plate, the inclined portion is slantingly arranged between the supporting portion and the bottom plate; when the driving component is in the first position, the elevating component is supported on the supporting portion for exposing the connector out of the housing; when the driving component is in the second position, the elevating component is supported on the inclined portion for retracting the connector into the housing.

5. The docking station as claimed in claim 4, wherein the elevating portion comprises a resisting portion connected an end of the inclined portion opposite to the supporting portion for resisting the elevating component when the driving component is in the second position.

6. The docking station as claimed in claim 5, wherein the elevating portion comprises an engaging portion, the engaging portion connects to an end of the resisting portion opposite to the inclined portion and is parallel to the inclined portion; the engaging portion, the resisting portion and the inclined portion corporately define a groove; the elevating component comprises a base and at least one sliding post protruding from the base, the at least one sliding post is received in the groove for allowing the elevating component to slide relative to the driving component.

7. The docking station as claimed in claim 2, wherein the elevating mechanism comprises an operating component, the operating component is rotatably connected to the housing and is capable of driving the driving component to move between the first position and the second position.

8. The docking station as claimed in claim 7, wherein the operating component comprises a body, the body comprises a first portion, a second portion connected to the first portion and a protruding portion protruded from the first portion; the second portion is inclined at an angle with respect to the first portion and rotatably connects to the housing, the driving component is secured to the protruding portion.

9. The docking station as claimed in claim 8, wherein the operating component comprises an operating portion secured to the body, the operating portion is capable of sliding relative to the housing in a first direction for driving the body to rotate relative to the housing.

10. The docking station as claimed in claim 9, wherein the operating component comprises a fixing component, the operating portion comprises a first arm, a second arm, a connecting portion and a handle;
the first arm and the second arm are positioned on opposite surfaces of the fixing portion, the connecting portion is arranged between two ends of the first and second arms, and the handle protrudes from the first arm and is exposed out of the housing.

11. The docking station as claimed in claim 1, wherein the housing comprises a lower cover, an upper cover and a conducting component, the conducting component is secured to the lower cover by an elastic component and protrudes out of the upper cover for connecting with the electronic device and transmitting any static electricity produced by the electronic device to ground.

12. An elevating mechanism for elevating a connector relative to a housing, comprising:
a driving component movably secured to the housing and capable of being moved between a first position and a second position; and
an elevating component movably secured to the driving component;
wherein the connector is secured to the elevating component, when the driving component moves from the second position to the first position, the elevating component is capable of being driven by the driving component to protrude the connector out of the housing; when the driving component moves from the first position to the second position, the elevating component is capable of being driven by the driving component to retract the connector into the housing.

13. The elevating mechanism as claimed in claim 12, wherein the driving component comprises a bottom plate and an elevating portion, the elevating portion comprises a supporting portion and an inclined portion slantingly connected to the supporting portion; the vertical height between an end of the inclined portion connected to the supporting portion and the bottom plate is larger than the vertical height between an end of the inclined portion opposite to the supporting portion and the bottom plate.

14. The elevating mechanism as claimed in claim 13, wherein the supporting portion is parallel to the bottom plate, the inclined portion is slantingly arranged between the supporting portion and the bottom plate; when the driving component is in the first position, the elevating component is supported on the supporting portion for exposing the connector out of the housing; when the driving component is in the second position, the elevating component is supported on the inclined portion for retracting the connector into the housing.

15. The elevating mechanism as claimed in claim 14, wherein the elevating portion comprises a resisting portion connected to an end of the inclined portion opposite to the supporting portion for resisting the elevating component when the driving component is in the second position.

16. The elevating mechanism as claimed in claim 15, wherein the elevating portion comprises an engaging portion, the engaging portion connects to an end of the resisting portion opposite to inclined portion and is parallel to the inclined portion; the engaging portion, the resisting portion and the inclined portion corporately define a groove; the elevating component comprises a base and at least one sliding post protruding from the base, the at least one sliding post is received in the groove for allowing the elevating component to slide relative to the driving component.

17. The elevating mechanism as claimed in claim 12, wherein the elevating component comprises an operating component, the operating component is rotatably connected to the housing and is capable of driving the driving component to move between the first position and the second position.

18. The elevating mechanism as claimed in claim 17, wherein the operating component comprises a body, the body comprises a first portion, a second portion connected to the first portion and a protruding portion protruded from the first portion; the second portion is inclined at an angle with respective to the first portion and rotatably connects to the housing, the driving component is secured to the protruding portion.

19. The elevating mechanism as claimed in claim 18, wherein the operating component comprises an operating portion secured to the body, the operating portion is capable of sliding relative to the housing in a first direction for driving the body to rotate relative to the housing.

20. The elevating mechanism as claimed in claim 19, wherein the operating component comprises a fixing component, the operating portion comprises a first arm, a second arm, a connecting portion and a handle; the first arm and the second arm are positioned on opposite surfaces of the fixing portion, the connecting portion is arranged between two ends of the first and second arms, and the handle protrudes from the first arm and is exposed out of the housing.
